(19) United States
(12) Patent Application Publication
(10) Pub. No.: US 2018/0361724 A1
(43) Pub. Date: Dec. 20, 2018

(54) DIISOCYANATE-SCAVENGING PACKAGING LAMINATES

(71) Applicant: Bemis Company, Inc., Neenah, WI (US)

(72) Inventors: Devanshu V. Mehta, Menasha, WI (US); James C. Huang, Oshkosh, WI (US); Kevin P. Nelson, Appleton, WI (US)

(21) Appl. No.: 16/060,369

(22) PCT Filed: Dec. 7, 2015
(86) PCT No.: PCT/US15/64294

§ 371 Date: Jun. 7, 2018

(51) Int. Cl. B32B 27/40; B32B 7/12; B65D 65/40; C09J 175/08; C08J 5/12

(52) U.S. Cl. CPC B32B 27/40; B32B 7/12; B65D 65/40; C09J 175/08; C08J 5/128; C08J 2367/02; C08J 2475/08; C08J 2323/06; C08J 2423/08; C08J 2471/02; B32B 2439/70

(57) ABSTRACT

The present invention is directed to packaging laminates for containing a food or pharmaceutical/medical product which includes an exterior film, a multilayer interior film comprising a product-contact layer, a diisocyanate-scavenging layer and an exterior film-contact layer, and a polyurethane adhesive layer bonding the exterior film to the multilayer interior film. The present invention reduces the amount of any unreacted diisocyanate precursor and primary amines which can migrate to a product in packaging assemblies formed with a polyurethane adhesive. This is achieved when an interior film (commonly known as a sealant film) includes a layer comprising a polyether polyol which is not in direct contact with the polyurethane adhesive. With this approach, the polyether polyol reacts with any residua! diisocyanate and/or primary amines which migrates from the polyurethane adhesive through the laminated assembly and thus, neutralizes any potential undesirable effects of these compounds.

### BACKGROUND OF THE INVENTION

The present invention relates generally to primary packaging for food and pharmaceutical products, and in particular to packaging laminates for scavenging residual diisocyanate, including aromatic diisocyanate and scavenging primary amines, including primary aromatic amines which may remain in the packaging assembly.

Polymers used in the packaging arts that do not bind together by standard coextrusion methods can be joined by lamination. Lamination of flexible materials (common films are PET, PP, polyethylene (PE), polyamide (PA), but also paper and aluminum foil) used for packaging materials in contact with food is today usually done with reactive two-component adhesives, solvent-based, water-based or solvent-free (100% solids) based on polyurethane chemistry.

Solventless polyurethane adhesives are the most widely used of the 100% solids lamination adhesive products in the packaging arts. These are two-part adhesive systems which comprise a diisocyanate precursor, typically an aromatic diisocyanate precursor, and a polyol (polyether or polyester based) precursor. These adhesives typically contain excess unreacted diisocyanate precursor which lowers the viscosity and thus making them easier to handle and adhere to a variety of substrates. Often aromatic diisocyanate precursors are selected to obtain good adhesion under moist and low temperature conditions. Aromatic diisocyanate precursors are also cheaper than aliphatic systems and for this reason are more commonly used than aliphatic diisocyanate precursors.

However, even though the adhesive is sufficiently cured to develop good bond strength between two laminated substrates, some residual unreacted diisocyanate precursor may be present in the bonded assembly. Any residual amount of unreacted diisocyanate is considered undesirable since they have a tendency to migrate and react with other components of the laminated assembly weakening its structural integrity. One approach to reducing the amount of unreacted diisocyanate is to place the laminated assembly in storage for several weeks or days prior to its use to allow any unreacted diisocyanate to further react with any remaining polyol. This strategy adds considerably to the cost of manufacture because of added inventory management and increases in order-to-delivery time which reduces manufacturing efficiency.

While the laminated assembly is in storage, unreacted diisocyanate may also react with moisture trapped during the coating of the adhesive, moisture from an atmosphere under high humidity or moisture from a food product. Diisocyanate and water react to form primary amines and primary aromatic amines from aromatic diisocyanate. Primary aromatic amines may be consumed by its continuing reaction with diisocyanate still present in the adhesive to form polyurea. However, unreacted primary aromatic amines can also migrate within packaging laminate assembly to the packaged product. Regulatory agencies limit the amount of extractable primary aromatic amines in applications that come into contact with people because of their potential toxicity. Accordingly, manufacturers of packaging materials need to reduce the level of primary aromatic amines that can be transferred from the package into foodstuffs and pharmaceuticals.

For food and pharmaceutical containers, pouch, bags, and the like, the contact between the container and the food or pharmaceutical product should not result in appreciable amounts of unreacted diisocyanate and/or primary aromatic amine being present in or on the packaged product.

### SUMMARY OF THE INVENTION

The present invention is directed to packaging laminates for containing a food or pharmaceutical/medical product which includes: i) an exterior film, ii) a multilayer interior film comprising a product-contact layer, a diisocyanate-scavenging layer and an exterior film-contact layer, and iii) a polyurethane adhesive layer bonding the exterior film to the multilayer interior film. The present invention reduces the amount of any unreacted diisocyanate precursor and primary amines which migrate to a product in packaging assemblies formed with a polyurethane adhesive. This is achieved when an interior film (commonly known as a sealant film) includes a layer comprising a polyether polyol which is not in direct contact with the polyurethane adhesive. With this approach, the polyether polyol reacts with any residual diisocyanate which migrates from the polyurethane adhesive through the laminated assembly and thus, neutralizes any potential undesirable effects of these migrating compounds. A further advantage of this invention is that it improves manufacturing efficiency by shortening order-to-delivery times because there is no longer the need to store the packaging laminates after they have been made to reduce the level of diisocyanate and/or primary aromatic amines.

As used herein the terms “exterior” and “interior” refer to the outer and inner surfaces of a container, respectively, formed from the packaging laminates of the present invention. Accordingly, the interior film of the present invention will have a layer which is in direct contact with a packaged product (which is referred to herein as the “product-contact layer”). The interior film may include film layers which function as water, gas and/or chemical barriers. The exterior film of the present invention will not be in direct contact with the packaged product and includes at least one layer which functions as a water and/or gas barrier. The interior film layer comprising the highest concentration of polyether polyol is referred to as the “diisocyanate-scavenging layer.” It is contemplated that the laminate assemblies of the present invention can be converted into various packaging products, especially food packaging laminates, including but not limited to bags, pouches, stand-up pouches, zipped pouches, over-wraps, and trays; pharmaceutical packaging laminates including blister packaging; and medical packaging for surgical instruments and medical devices.

### Polyether Polyols

An important aspect of the present invention is that the diisocyanate-scavenging layer of the multilayer interior film comprises a polyether polyol. As used throughout this disclosure, the term “polyether polyol” refers to any oligomer or polymer containing at least a repeating ether linkage —(R—O—R)— and having two or more hydroxy groups (—OH) as terminal and/or pendant functional groups attached thereto.

In some preferred embodiments, the polyether polyol can be defined by the generic chemical formula:

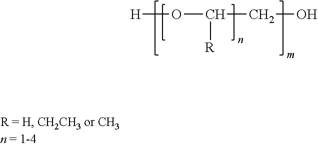

In such embodiments, the polyether polyol having the above generic chemical formula includes oligomers and polymers such as, but not limited to, poly(ethylene glycol), also referred to as poly(ethylene oxide) and poly(oxyethylene); poly(propylene glycol) or otherwise referred to as poly(propylene oxide); poly(butylene glycol), sometimes referred to as poly(oxybutylene diol); poly(tetramethylene oxide), also referred to as poly(tetrahydrofuran), poly(tetramethylene ether) glycol, poly(oxobutylene) glycol and poly(oxytetramethylene) glycol.

In some other preferred embodiments, the polyether polyol can be defined by the generic chemical formula:

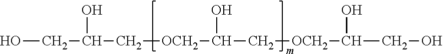

In some other preferred embodiments, the polyether polyol can be defined by the generic chemical formula:

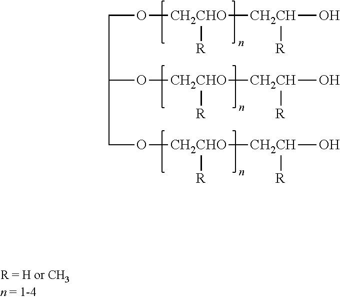

Another important aspect of the present invention is use of polyether polyols having relatively low weight average molecular weights of between 600 gram/mole and 8000 gram/mole. In such embodiments, the polyether polyols may be readily blended with various thermoplastic resins to a desired ratio.

### Diisocyanate-Scavenging Layer

In some preferred embodiments, the diisocyanate-scavenging layer comprises between 1500 ppm and 7500 ppm of polyether polyol relative to the total weight of the multilayer interior film. In such preferred embodiments, the polyether polyol is incorporated into a thermoplastic resin. Typical thermoplastic resins which may be used to form the diisocyanate-scavenging layer include, but not limited to polyolefins such as high density polyethylene, low density polyethylene, linear low density polyethylene, ethylene/α-olefin copolymer, cyclic olefin copolymer, ethylene vinyl acetate copolymer, polypropylene, polybutylene; polyamide; polyester and blends thereof.

There are several methods which could be used to produce the diisocyanate-scavenging layer compositions of the present invention. All the components of the diisocyanate-scavenging layer may be dry blended in the required weight ratio in a suitable device such as a tumble blender. The resulting dry blend is then melted in suitable equipment such as an extruder. Alternatively, a masterbatch could be prepared by metering the layer components directly into a single- or twin-screw extruder. The specific conditions for operating a single-screw extruder will differ from that of a twin-screw extruder, but those skilled in the art can readily determine the necessary operating conditions needed to prepare masterbatches suitable for use with the present invention.

Since polyether polyol reacts with migrating unreacted diisocyanate precursor to form polyurethane, the diisocyanate-scavenging layer may also include polyurethane as a consequence of these chemical interactions.

One useful method of varying the concentration of polyether polyol relative to the total weight of the multilayer interior film is by the changing the relative thickness of the diisocyanate-scavenging layer. One skilled in the art will recognize that the basis weight of the individual layer corresponds to its thickness. Accordingly, increasing the basis weight (lbs./ream) of a layer having a particular weight percentage of polyether polyol increases the concentration of polyether polyol (ppm) relative to the total weight of the film.

### Multilayer Interior Film

The multilayer interior film having the three required film layers may have additional film layers. In some preferred embodiments, these additional layers can be positioned between the diisocyanate-scavenging layer and product-contact layer. It is also contemplated that additional film layers may be positioned between the diisocyanate-scavenging layer and the exterior film-contact layer. In such embodiments, the additional layer may be composed of water, chemical and/or gas barrier materials which are well known to those skilled in the art.

The multilayer interior film may be fabricated by several different conventional methods known in the art including blown film coextrusion, slot cast coextrusion, extrusion lamination, extrusion coating and combinations thereof. In a preferred embodiment, the multilayer interior film was produced using a coextrusion blown film line. In this method, the line was equipped with multiple extruders which fed into a multi-manifold circular die head through which the film layers are forced and formed into a cylindrical multilayer film bubble. The bubble was quenched, then collapsed and formed into a multilayer film. Films produced using blown film processes are known in the art and have been described, for example, in The Encyclopedia of Chemical Technology, Kirk-Othmer, 3rd ed., John Wiley & Sons, New York, 1981, Vol. 16, pp. 416-417 and Vol. 18, pp. 191-192, the disclosures of which are incorporated herein by reference. Typically, the resins and any additives forming one or more film layers were introduced to an extruder where the resins were melt-plastified by heating and then transferred to an extrusion (or coextrusion) die for formation into the bubble or tube. If desired, resins may be blended or mechanically mixed by well-known methods using commercially available equipment including tumblers, mixers or blenders, and well-known additives such as processing aids, slip agents, anti-blocking agents, pigments and mixtures thereof may be incorporated into the resin by blending prior to extrusion. The extruder and die temperatures will generally depend upon the particular resin(s) containing mixtures being processed, and suitable temperature ranges for commercially available resins are generally known in the art or are provided in technical bulletins made available by resin manufacturers. The specific conditions for operation of any specific extrusion equipment can be readily determined by one skilled in the art. After formation, the bubble is cooled, collapsed, slit, and wound around a roller for further processing.

The product-contact layer of the multilayer interior film may include any thermoplastic material used for heat sealing a packaging web to itself or other packaging components. In some preferred embodiments, the product-contact layer is a heat sealable thermoplastic resin such as, but not limited to, polyethylene homopolymers and copolymers including high density polyethylene, low density polyethylene, linear low density polyethylene, ethylene/α-olefin copolymer, cyclic olefin copolymer, ethylene vinyl acetate copolymer, polypropylene, polyethylene/polypropylene copolymer, polybutylene, ionomer and blends thereof. The product-contact layer may also include a pressure sensitive adhesive or a blend of pressure sensitive adhesive and some other heat sealable thermoplastic resin as mentioned above. For some applications, the product-contact layer has a composition which functions as a chemical barrier and/or water barrier and/or gas barrier.

The exterior film-contact layer of the multilayer interior film may be any thermoplastic substrate which will adhere to the polyurethane adhesive. In some preferred embodiments, the exterior film-contact layer is any thermoplastic which is readily coextruded together with the diisocyanate-scavenging and product-contact layers. In some preferred embodiments, the composition of the exterior film-contact layer is identical to the composition of the product-contact layer.

### Exterior Film

The exterior film of the present invention may comprise any material which readily bonds to polyurethane adhesive. Such materials include mono- and multilayer thermoplastic substrates such as polyester, polyamide and polyolefin films and combinations thereof. In some preferred embodiments, the exterior film comprises an oriented monolayer film. Such films include uniaxial- or biaxial oriented polyethylene terephthalate, oriented nylon and oriented polypropylene. Other suitable materials for use as an exterior film include paper, paperboard, cardboard and cellulose fiber-containing substrates.

### Polyurethane Adhesive

The polyurethane adhesive suitable for use in the present invention may be any two-component precursor system comprising diisocyanate precursor and polyol precursor. The diisocyanate precursors are di- or polyfunctional isocyanates containing two or more than two —NCO (isocyanate) groups per molecule or polymer repeating unit. These can be aliphatic, cycloaliphatic, polycyclic or aromatic in nature such as toluene diisocyanate (TDI), methylene diphenyl diisocyanate (MDI), xylene diisocyanate (XDI), meta-tetramethylxylylene diisocyanate (TMXDI), hydrogenated xylene diisocyanate (HXDI), naphthalene 1,5-diisocyanate (NDI), phenylene diisocyanate (PPDI), 3,3′-dimethyldiphenyl-4, 4′-diisocyanate (DDDI), 1,6 hexamethylene diisocyanate (HDI), 2,2,4-trimethyihexamethylene diisocyanate (TMDI), isophorone diisocyanate (IPDI), 4,4′-dicyclohexylmethane diisocyanate (H12MDI), norbomane diisocyanate (NDI), 4,4′-dibenzyl diisocyanate (DBDI). The polyol precursors are di- or polyfunctional alcohols containing two or more than two —OH (hydroxy) groups per molecule or polymer repeating unit. The polyol may be synthesized to include ether, ester or ether/ester linkages as part of its chemical structure. Such polyols may be referred to as polyether polyols, polyester polyols and polyether/polyester polyols, respectively. Polyurethane adhesives are well known in the art and a number of suitable examples are commercially available. Examples of such adhesives include, but are not limited to, those sold under the trade name MOR-FREE™ by The Dow Chemical Company, Inc. (Midland, Mich.) and LOCTITE® LIOFOL by Henkel AG & Company (Düsseldorf, Germany).

### BRIEF DESCRIPTION OF THE DRAWINGS

Further features and advantages of the present invention will become apparent from the following detailed description, taken in combination with the appended drawings, in which:

FIG. 1 illustrates a schematic of one preferred embodiment of a packaging laminate according to the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### Preparation of Masterbatch of the Diisocyanate Scavenging Layer

Compounding of a masterbatch for the diisocyanate-scavenging layer was done in advance to make the multilayer interior film. The masterbatch was compounded using APV MP2050 co-rotating 50 mm twin-screw extruder with a dual segment barrel (10:1 and 15:1) 25:1 ID machine. The drive was a 38 HP motor with a maximum screw speed of 600 RPM. The extruder has several barrel-temperature zones, including the die, and was water cooled. The extruder was heated to a temperature from 82° F. (180° C.) to 193° C. (380° F.). The screw speed was kept at about 300 RPM's. The specific conditions of the extruder can vary depending upon the specific thermoplastic resin and polyether polyol used to form the diisocyanate scavenging layer and the relative ratio of these components. The specific conditions of operation can readily be determined by one skilled in the art. The extruder extruded the layer masterbatch composition as strands which were then cooled and cut into pellets for subsequent use. In one preferred embodiment, a masterbatch was formed under the conditions described above which included a composition of about 97 wt.-% of a linear low density polyethylene (Westlake LF 1040) having a melt index of 2.0 gram/10 min. and a density of 0.919 gram/cm³ supplied by Westlake Polymers LP (Houston, Tex.); about 2 wt.-% of a poly(ethylene glycol) (CARBOWAX™ SENTRY™ polyethylene glycol (PEG) 3350) having a weight average molecular weight of between 3015 and 3685, a density at 60° C. of 1.09 gram/cm³, and a range of average hydroxyl number of between 30 and 38 milligram KOH/gram supplied by The Dow Chemical Company, Inc. (Midland, Mich.); and about 1 wt.-% of a fluoropolymer elastomer processing aid (3M™ Dynamar™ FX9613) supplied by 3M Company, Inc. (St. Paul, Minn.). It is also contemplated that a masterbatch can be prepared without the use of any processing aids.

### Preparation of Laminates

Any suitable method of making flexible laminates can be used to form the laminates of the present invention. One specific method for use with solventless polyurethane adhesives included combining the diisocyanate precursor and the polyol precursor of the adhesive and then immediately sending the mixed components onto the lamination gravure rollers of a conventional plastic film laminator. In one preferred embodiment, a 1:1 ratio of diisocyanate to polyol precursor was used. Useful coating temperatures range from 20° C. to 75° C. Lower temperatures are preferred during the process in order to extend the working life of the adhesive composition. The mixed adhesive was then applied to an in-line corona treated surface of the exterior film. The coating weight of the adhesive may vary broadly depending on the desired properties of the laminate. Useful adhesive coating weights include from 0.5 grams/meter² to 3 grams/meter² and preferably from 1.5 grams/meter² to 2.5 grams/meter². Once coated, the exterior film was mated to the multilayer interior film by pressing the exterior film/adhesive/interior film structure together by use of nip rollers. The laminate was then wound onto a production roll for curing of the adhesive.

### Preparation of Pouches

Test samples of different laminates were removed from their production roll after 24 hours, 48 hours and 72 hours curing times. A 100 in² pouch was formed from the laminate samples using a conventional heat sealing apparatus, and then filled with 750 mL of food simulant (3% acetic acid solution) so that there was minimal headspace within the pouch. Specific heat sealing conditions such as sealing temperature, sealing pressure and sealing time can vary depending upon the specific thermoplastic used for the food-contact layer and would be readily known to one skilled in the art. The food simulant was prepared by diluting 1.5 liters of glacial acetic acid to 50 liters using ultra purified water.

### Efficacy of the Diisocyanate-Scavenging Layer

The approach taken to test the efficacy of the diisocyanate-scavenging layer was to make pouches after the three post-lamination times, fill the pouches with a suitable food simulant, and seal and store the pouches. After filling, the pouches were kept in an air circulated oven for 2 hours at 70° C., after which a 20 mL sample of food simulant within the pouch was retrieved. The amount of extractable primary aromatic amines in the food simulant was then measured. One method of determining the amount of migratory amines is with the use of HPLC/MS coupling which measures the amines directly. Because it was believed that the lamination adhesive used for this study (MOR-FREE™ 403A/MOR-FREE™ C-117) contained three structural isomers of methylene diphenyl diisocyanate (MDI), i.e., 2,2′-methylene diphenyl diisocyanate, 2,4′-methylene diphenyl diisocyanate and 4,4′-methylene diphenyl diisocyanate, the corresponding primary aromatic amines of these diisocyanate isomers were detected via liquid chromatography/mass spectrometry. The specific aromatic amines detected were 2,2′-methylenedianiline (2,2′-MDA), 2,4′-methylenedianiline (2,4′-MDA) and 4,4′-methylenedianiline (4,4′-MDA). A API 4000™ LC/MS/MS system manufactured by AB Sciex LLC (Framingham, Mass.) which combines high pressure liquid chromatography (HPLC) with a quadrupole mass spectrometry (MS) was used to determine the concentration of the three primary aromatic amine isomers in each sample of food simulant. The retention time and concentration for each primary aromatic amine isomer were calibrated using commercial available analytical standards for each primary aromatic amine isomer using a Phenomenex® Luna C18(2) HPLC column manufactured by Phenomenex Inc. (Torrance, Calif.). A 1 mL aliquot of the 20 mL sample of food simulant within each pouch was placed into an injection vial which had a 2 μL portion of analytical standards of each primary aromatic amine isomer.

### Working Examples

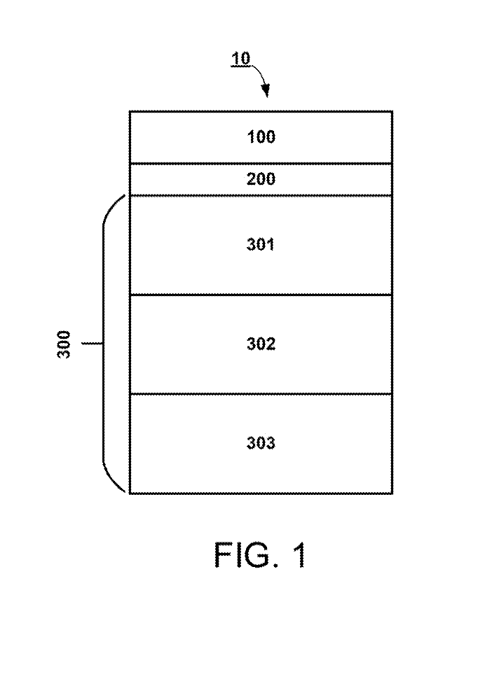

FIG. 1 illustrates one preferred embodiment of a laminate according to the present invention. In this drawing, laminate 10 comprises an exterior film 100, a polyurethane adhesive layer 200, and a multilayer interior film 300 comprising a exterior film-contact layer 301, a diisocyanate-scavenging layer 302 and a product-contact layer 303.

In the following Control Example and Examples 1-4, there is described various embodiments of a laminate 10 as illustrated in FIG. 1. In all these examples, the thickness of the total exterior film 100 vary between 0.44 mil and 0.48 mil, or had a basis weight of 9.5 lbs./ream, the total thickness of the polyurethane adhesive 200 was between 0.05 mil and 0.5 mil, or had a basis weight of 1.2 lbs./ream, and the total thickness of multilayer interior film 300 was about 2.5 mil or had a basis weight of 36.22 lbs./ream. The layer compositions of the exterior film, polyurethane adhesive and multilayer interior film are described below along with the individual thicknesses (basis weight) of each layer of the interior film. Also reported are the primary aromatic amines (2,2′-MDA; 2,4′-MDA and 4,4′-MDA) extraction results by HPLC/MS spectroscopy taken after 24 hours, 48 hours and 72 hours post-lamination. These examples are intended to be representative of specific embodiments of the invention and are not intended to be limiting to the scope of the invention.

### Control Example

The Control Example had a structure and layer compositions as described below and as illustrated in FIG. 1. No polyether polyol was present in the diisocyanate-scavenging layer 302 of interior film 300 of the Control Example. The extraction results by HPLC/MS spectroscopy are reported in TABLE 1.
Exterior Film 100: 100 wt.-% of a 44 gauge biaxially oriented polyethylene terephthalate crystalline polyethylene terephthalate (OPET)-SARAfil TFCO (Polyplex Corporation, Uttar Pradesh, India).
Polyurethane Adhesive 200: 100 wt.-% of a solventless, two-component polyurethane adhesive-MOR-FREE™ 403A/MOR-FREE™ C-117 (The Dow Chemical Company, Midland, Mich.)
Exterior Film-Contact layer 301: 100 wt.-% of a linear low density polyethylene (LLDPE) having a melt index of 1.0 gram/10 min and a density of 0.922 gram/cm³-DOWLEX™ 2045G (The Dow Chemical Company, Midland, Mich.). Total basis weight of 39.98.
Diisocyanate-Scavenging Layer 302: 100 wt.-% of a linear low density polyethylene (LLDPE) having a melt index of 2.0 gram/10 min and a density of 0.918 gram/cm³-Mobil™ LLDPE LL 1002YB (ExxonMobil Chemical Company, Houston, Tex.). Total basis weight of 25.02.
Product-Contact Layer 303: 100 wt.-% of a medium density polyethylene (MDPE) having a melt index of 2.3 gram/10 min and a density of 0.929 gram/cm³-ExxonMobil™ LDPE LD 129.24 (Exxon Mobil Chemical Company, Inc., Houston, Tex.). Total basis weight of 15.

TABLE 1
Extractable Primary Aromatic Amines

| | 2,2′-MDA | 2,4′-MDA | 4,4′-MDA | Total MDAs |
|---|---|---|---|---|
| Cure Time | (ppb) | (ppb) | (ppb) | (ppb) |
| 24 Hours | 33.83 | 98.73 | 5.77 | 138.33 |
| 48 Hours | 19.13 | 19.83 | 0 | 38.96 |
| 72 Hours | 16.6 | 9.82 | 0 | 28.42 |

### Example 1

Example 1 had a structure and layer compositions as described above in the Control Example and as illustrated in FIG. 1, except for the composition of the diisocyanate-scavenging layer 302 of the interior film 300. In this example, the composition of layer 302 was a blend of 97 wt.-% of a linear low density polyethylene (LLDPE) having a melt index of 2.0 gram/10 min and a density of 0.919 gram/cm³-Westlake LF 1040 (Houston, Tex.); about 2 wt.-% of a poly(ethylene glycol)-CARBOWAX™ SENTRY™ polyethylene glycol (PEG) 3350 having a weight average molecular weight of between 3015 and 3685, a density at 60° C. of 1.09 gram/cm³, and a range of average hydroxyl number of between 30 and 38 milligram KOH/gram (The Dow Chemical Company, Inc., Midland, Mich.); and about 1 wt.-% of a fluoroelastomer processing aid-3M™ Dynamar™ FX9613 (3M Company, Inc., St. Paul, Minn.). The CARBOWAX™ SENTRY™ polyethylene glycol (PEG) 3350 is a food grade polyether polyol. This layer had a basis weight of 4.5 lbs./ream which corresponded to 2485 ppm of polyether polyol relative to the total weight of the interior film 300. The extraction results by HPLC/MS spectroscopy are reported in TABLE 2.

TABLE 2
Extractable Primary Aromatic Amines

| | 2,2′-MDA | 2,4′-MDA | 4,4′-MDA | Total MDAs |
|---|---|---|---|---|
| Cure Time | (ppb) | (ppb) | (ppb) | (ppb) |
| 24 Hours | 19.07 | 32.13 | 26.87 | 78.07 |
| 48 Hours | 10.71 | 2.64 | 15.03 | 28.38 |
| 72 Hours | 5.83 | 0.71 | 8.21 | 14.75 |

### Example 2

Example 2 had a structure and layer compositions as described above in the Example 1 and as illustrated in FIG. 1, except that the diisocyanate-scavenging layer 302 had a basis weight of 6.8 lbs./ream which corresponded to 3750 ppm of polyether polyol relative to the total weight of the interior film 300. The extraction results by HPLC/MS spectroscopy are reported in TABLE 3.

TABLE 3
Extractable Primary Aromatic Amines

| | 2,2′-MDA | 2,4′-MDA | 4,4′-MDA | Total MDAs |
|---|---|---|---|---|
| Cure Time | (ppb) | (ppb) | (ppb) | (ppb) |
| 24 Hours | 20.5 | 6.95 | 0 | 27.45 |
| 48 Hours | 9.5 | 0.79 | 0 | 10.29 |
| 72 Hours | 7.78 | 0.7 | 0 | 8.48 |

### Example 3

Example 3 had a structure and layer compositions as described above in the Example 1 and as illustrated in FIG. 1, except that the diisocyanate-scavenging layer 302 had a basis weight of 7.0 lbs./ream which corresponded to 3865 ppm of polyether polyol relative to the total weight of the interior film 300. The extraction results by HPLC/MS spectroscopy are reported in TABLE 4.

TABLE 4
Extractable Primary Aromatic Amines

| | 2,2′-MDA | 2,4′-MDA | 4,4′-MDA | Total MDAs |
|---|---|---|---|---|
| Cure Time | (ppb) | (ppb) | (ppb) | (ppb) |
| 24 Hours | 19.07 | 10.29 | 0 | 29.36 |
| 48 Hours | 10.71 | 1.3 | 0 | 12.01 |
| 72 Hours | 5.83 | 0.6 | 0 | 6.43 |

### Example 4

Example 4 had a structure and layer compositions as described above in the Example 1 and as illustrated in FIG. 1, except that the diisocyanate-scavenging layer 302 comprised 67 wt.-% of an ultra-low density polyethylene having a melt index of 0.80 gram/10 min and a density of 0.914 gram/cm³-ATTANE™ NG 4701G (The Dow Chemical Company, Inc., Midland, Mich.), 31.51 wt.-% of an ethylene vinyl acetate copolymer having a vinyl acetate content of 5.0 wt.-%, a melt index of 1.5 gram/10 min and a density of 0.927 gram/cm³-Petrothene® NA442 (LyondellBasell Industries, Houston, Tex.) and 1.49 wt.-% of a poly(tetramethylene oxide) having a weight average molecular weight of between 1950 and 2050 gram/mole-PolyTHF® 2000 Polyether (BASF Corporation, Florham Park, N.J.). The PolyTHF® 2000 Polyether is a food grade polyether polyol. This layer had a basis weight of 9.0 lbs./ream which corresponded to 1640 ppm of polyether polyol relative to the total weight of the interior film 300. The extraction results by HPLC/MS spectroscopy are reported in TABLE 5.

TABLE 5
Extractable Primary Aromatic Amines

| | 2,2′-MDA | 2,4′-MDA | 4.4′-MDA | Total MDAs |
|---|---|---|---|---|
| Cure Time | (ppb) | (ppb) | (ppb) | (ppb) |
| 24 Hours | 25.07 | 41.4 | 0.73 | 67.2 |
| 48 Hours | 15.37 | 6.27 | 0 | 21.64 |
| 72 Hours | 9.77 | 1.57 | 0 | 11.34 |

The above-described data demonstrate the efficiency of the packaging laminates of the present invention in reducing the level of primary aromatic amines to acceptably low levels, within a short period of time, to eliminate long storage times.

The above description and examples illustrate certain embodiments of the present invention and are not to be interpreted as limiting. Selection of particular embodiments, combinations thereof, modifications, and adaptations of the various embodiments, conditions and parameters normally encountered in the art will be apparent to those skilled in the art and are deemed to be within the spirit and scope of the present invention.

What is claimed is:

1. A packaging laminate comprising:
an exterior film;
a multilayer interior film comprising a product-contact layer, a diisocyanate-scavenging layer and an exterior film-contact layer;
a polyurethane adhesive layer bonding the exterior film to the exterior film-contact layer of the multilayer interior film;
wherein the diisocyanate-scavenging layer comprises a polyether polyol.

2. The packaging laminate according to claim 1, wherein the polyether polyol is defined by the chemical formula:

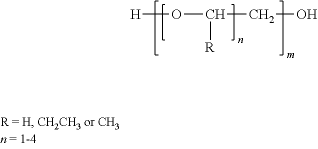

3. The packaging laminate according to claim 1, wherein the polyether polyol is defined by the chemical formula:

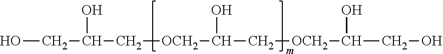

4. The packaging laminate according to claim 1, wherein the polyether polyol is defined by the chemical formula:

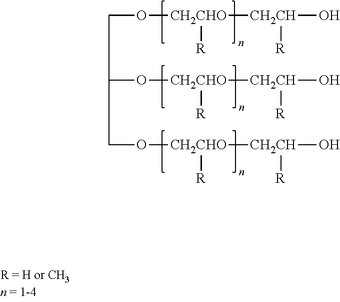

5. The packaging laminate according to claim 1, wherein the polyether polyol is selected from the group consisting of poly(ethylene glycol), poly(propylene glycol), poly(butylene glycol), poly(tetramethylene oxide) and blends thereof.

6. The packaging laminate according to claim 1, wherein the polyether polyol is poly(ethylene glycol).

7. The packaging laminate according to claim 1, wherein the polyether polyol has a minimum weight average molecular weight of at least 600 gram/mole.

8. The packaging laminate according to claim 1, wherein the polyether polyol has a maximum weight average molecular weight of 8000 gram/mole.

9. The packaging laminate according to claim 1, wherein the polyether polyol is a food grade polyether polyol.

10. The packaging laminate according to claim 1, wherein the diisocyanate-scavenging layer comprises a mixture of a polyolefin and a polyether polyol.

11. The packaging laminate according to claim 10, wherein the polyolefin comprises high density polyethylene, low density polyethylene, linear low density polyethylene, ethylene/α-olefin copolymer, ethylene vinyl acetate copolymer, polypropylene, polybutylene and blends thereof.

12. The packaging laminate according to claim 1, wherein the diisocyanate-scavenging layer comprises between 1500 ppm and 7500 ppm of polyether polyol relative to the total weight of the multilayer interior film.

13. The packaging laminate according to claim 1, wherein the diisocyanate-scavenging layer comprises polyurethane.

14. The packaging laminate according to claim 1, wherein the diisocyanate-scavenging layer is disposed between the product-contact layer and the exterior film-contact layer.

15. The packaging laminate according to claim 1, wherein the diisocyanate-scavenging layer is in direct contact with the exterior film-contact layer.

16. The packaging laminate according to claim 1, wherein the diisocyanate-scavenging layer is in direct contact with the product-contact layer and the exterior film-contact layer.

17. The packaging laminate according to claim 1, wherein the polyurethane adhesive comprises a two-component polyurethane adhesive.

18. The packaging laminate according to claim 17, wherein the two-component polyurethane adhesive comprises a diisocyanate and a polyol.

19. The packaging laminate according to claim 17, wherein the two-component polyurethane adhesive comprises an aromatic diisocyanate and a polyol.

20. The packaging laminate according to claim 1, wherein the exterior film comprises an exterior film layer comprising oriented polyethylene terephthalate, oriented polypropylene or oriented polyamide.
